(19) United States
(12) Patent Application Publication
(10) Pub. No.: US 2014/0355683 A1
(43) Pub. Date: Dec. 4, 2014

(54) Data Encoding for Attenuating Image Encoders

(71) Applicant: Altera Corporation, San Jose, CA (US)

(72) Inventors: YI LING, REDWOOD CITY, CA (US); ALBERT W WEGENER, APTOS HILLS, CA (US)

(73) Assignee: Altera Corporation, San Jose, CA (US)

(21) Appl. No.: 13/907,670

(22) Filed: May 31, 2013

(51) Int. Cl. H04N 19/91; H04N 19/80; H04N 19/583; H04N 19/89

(52) U.S. Cl. CPC H04N 19/00951; H04N 19/00933; H04N 19/0089; H04N 19/00733
USPC 375/240.16; 375/240.01; 375/240.27; 375/240.29; 375/240.12

(57) ABSTRACT

A hybrid access encoder includes one or more improvements to attenuation-based image and video encoders using images. The hybrid access encoder supports tradeoffs between encoded bit rate and decoded image and video quality. The hybrid access encoder monitors multiple redundancy removal filters and selects the best-performing filter for encoding. The hybrid access encoder operates in a mode that specifies a target decoded image quality and a target encoded bit rate, giving preference to one metric (image quality or bit rate) when both target values cannot be achieved. The hybrid access encoder performs a plurality of passes across each image and can optimize one or more parameters of the encoder settings between passes. A user interface allows users to control the tradeoff between decoded video quality and battery life for a mobile device.

### BACKGROUND

The technology described herein encodes pixel data of an image or video frame using hybrid access encoder that achieves either fixed-rate, fixed-quality, or a hybrid fixed-rate/fixed-quality results. It is often desirable to capture, process, display, and store images in mobile, portable, and stationary devices. The prodigious amount of pixels captured during image and video processing can create bottlenecks for system speed and performance in such devices. In imaging applications using mobile processors (smart phones and tablets), low-complexity encoding and decoding techniques that minimize power consumption and maximize battery life are preferred. Hybrid access encoders that attenuate or quantize the pixels from an image or a video frame tend to be among the most energy-efficient and silicon area-efficient image compression methods. As used in this patent application, the term “quantization” describes lossy compression techniques that reduce pixel color depths by an integer amount (such as 2 bits) while the term “attenuation” describes lossy compression techniques that reduce pixel color depths by a fractional amount (such as 1.25 bits).

Standard video compression algorithms such as JPEG2000, MPEG2 and H.264 reduce image and video bandwidth and storage bottlenecks at the cost of additional computations and access storage (previously decoded image frames). In video applications, if lossless or lossy compression of macroblocks within a reference frame were used to reduce memory capacity requirements and to reduce memory access time, it would be desirable that such macroblock encoding be computationally efficient in order to minimize demands on computing resources. It would be further desirable that the macroblock encoding method support multiple methods that independently or jointly offer users multiple modes and settings to optimize the user's desired bit rate vs. image quality tradeoff.

Imaging systems are ubiquitous in both consumer and industrial applications using microprocessors, computers, and dedicated integrated circuits called systems-on-chip (SoCs) or application-specific integrated circuits (ASICs). Such imaging systems can be found in personal computers, laptops, tablets, and smart phones; in televisions, satellite and cable television systems, and set-top boxes (STBs); and in industrial imaging systems that include one or more cameras and a network for capturing video from monitored systems as diverse as factories, office buildings, and geographical regions (such as when unmanned aerial vehicles or satellites perform reconnaissance). Such imaging and video systems typically capture frames of image data from image sensors that require raster-based access. Similarly, images in such imaging and video systems typically use monitors or displays on which users view the captured still images or videos. Because digital video systems require memory access to tens or even hundreds of Megabytes (MByte) per second for recording or playback, several generations of video compression standards, including Moving Picture Experts Group (MPEG and MPEG2), ITU H.264, and the new H.265 (High Efficiency Video Codec) were developed to reduce memory bandwidth and capacity requirements of video recording and playback. These video processing standards achieve compression ratios between 10:1 and 50:1 by exploiting pixel similarities between successive frames. Many pixels in the current frame can be identical, or only slightly shifted horizontally and/or vertically, to corresponding pixels in previous frames. The aforementioned image compression standards operate by comparing areas of similarity between subsets (typically called macroblocks, or MacBlks) of the current image frame to equal-sized subsets in one or more previous frames, called “access.” The aforementioned standard video compression algorithms store one or more reference frame in a memory chip (integrated circuit or IC) that is typically separate from the chip (IC) performing the encoding and/or decoding algorithm. The interconnection between these two chips often comprises hundreds of pins and wires that consume considerable power as the video encoding and/or decoding IC reads/writes reference frame from/to the memory IC. Motion estimation (ME) and motion compensation (MC) processes reference frame uncompressed MacBlks (pieces of reference frame) in main memory, also called dynamic random access memory (DRAM) or double data rate (DDR) memory.

Especially in mobile and portable devices, where only a limited amount of power is available due to battery limitations, it is desirable to use as little power for video recording and playback as possible. A significant (>30%) amount of power is consumed during video encoding when the ME process accesses MacBlks in reference frame stored in off-chip DDR memory, and during video decoding when the MC process accesses MacBlks in reference frame stored in off-chip DDR memory. In today's portable computers, tablets, and smart phones, the video encoding and decoding process is often orchestrated by one or more cores of a multi-core integrated circuit (IC).

Commonly owned patents and applications describe a variety of attenuation-based compression techniques applicable to fixed-point, or integer, representations of numerical data or signal samples. These include U.S. Pat. No. 5,839,100 (the '100 patent), entitled “Lossless and loss-limited Compression of Sampled Data Signals” by Wegener, issued Nov. 17, 1998. The commonly owned U.S. Pat. No. 7,009,533, (the '533 patent) entitled “Adaptive Compression and Decompression of Bandlimited Signals,” by Wegener, issued Mar. 7, 2006, incorporated herein by reference, describes compression algorithms that are configurable based on the signal data characteristic and measurement of pertinent signal characteristics for compression. The commonly owned U.S. Pat. No. 8,301,803 (the '803 patent), entitled “Block Floating-point Compression of Signal Data,” by Wegener, issued Apr. 28, 2011, incorporated herein by reference, describes a block-floating-point encoder and decoder for integer samples. The commonly owned U.S. patent application Ser. No. 13/534,330 (the '330 application), filed Jun. 27, 2012, entitled “Computationally Efficient Compression of Floating-Point Data,” by Wegener, incorporated herein by reference, describes algorithms for direct compression floating-point data by processing the exponent values and the mantissa values of the floating-point format. The commonly owned patent application Ser. No. 13/617,061 (the '061 application), filed Sep. 14, 2012, entitled “Conversion and Compression of Floating-Point and Integer Data,” by Wegener, incorporated herein by reference, describes algorithms for converting floating-point data to integer data and compression of the integer data.

The commonly owned patent application Ser. No. 13/617,205 (the '205 application), filed Sep. 14, 2012, entitled “Data Compression for Direct Memory Access Transfers,” by Wegener, incorporated herein by reference, describes providing compression for direct memory access (DMA) transfers of data and parameters for compression via a DMA descriptor. The commonly owned patent application Ser. No. 13/616,898 (the '898 application), filed Sep. 14, 2012, entitled “Processing System and Method Including Data Compression API,” by Wegener, incorporated herein by reference, describes an application programming interface (API), including operations and parameters for the operations, which provides for data compression and decompression in conjunction with processes for moving data between memory elements of a memory system.

The commonly owned patent application Ser. No. 13/358,511 (the '511 application), filed Jan. 12, 2012, entitled “Raw Format Image Data Processing,” by Wegener, incorporated herein by reference, describes encoding of image sensor rasters during image capture, and the subsequent use of encoded rasters during image compression using a standard image compression algorithm such as JPEG or JPEG2000.

In order to better meet MacBlk access requirements during video capture, processing, and display, and to reduce memory utilization and complexity during both raster-based and block-based access, a need exists for a flexible, computationally efficient MacBlk encoding and decoding method that supports both raster and MacBlk access patterns.

### SUMMARY

In one embodiment, the access encoders described herein monitors a plurality of redundancy removal filters and selects the best-performing filter for encoding. In another embodiment, the access encoders described herein allows specification of a target or desired image quality metric. In another embodiment, the access encoders described herein operate in a hybrid mode that specifies a target decoded image quality and a target encoded bit rate, while giving preference to either metric (image quality or bit rate) when both target values cannot be achieved. In another embodiment, the access encoders perform a plurality of passes across the reference frame and optimizes one or more parameters of the encoder settings, which may include MacBlk size. In one aspect, the access encoding and decoding described herein may be implemented using resources of a computer system. In another aspect, the access encoding and decoding described herein may be implemented using a field-programmable gate array (FPGA), application-specific integrated circuit (ASIC), system-on-chip (SoC), or as an intellectual property (IP) block for an ASIC or SoC. Other aspects and advantages of the present invention can be seen on review of the drawings, the detailed description and the claims, which follow.

### BRIEF DESCRIPTION OF THE DRAWINGS

FIG. 1 is a block diagram of a computing system that captures, processes, stores, and displays digital image data, including an access encoder and access decoder, in accordance with a preferred embodiment.

FIG. 2 illustrates an example of a frame of pixels and how macroblocks are overlaid on image data.

FIG. 3 illustrates several examples of packing pixel data into a packet.

FIG. 4 is a block diagram of the access encoder, in accordance with a preferred embodiment.

FIG. 5 is a block diagram of an access decoder, in accordance with a preferred embodiment.

FIGS. 6A, 6B (collectively “FIG. 6” herein) illustrate examples of macroblock-based video encoding and decoding algorithms, such as MPEG2, H.264, and H.265 (HEVC), that use one or more reference frame stored in a memory for encoding a current frame of pixels, in accordance with a preferred embodiment.

FIGS. 7A, 7B (collectively “FIG. 7” herein) illustrate examples of systems in which a video encoder and a video decoder include an access encoder and an access decoder, in accordance with a preferred embodiment.

FIG. 8 illustrates two video frames, frame(i) and frame(i−1), where frame(i) follows frame(i−1) and associated difference equations.

FIG. 9 illustrates a block diagram of a programmable difference engine that could be implemented in software or hardware to create the example differences described with respect to FIG. 8, in accordance with a preferred embodiment.

FIGS. 10A, 10B (collectively “FIG. 10” herein) illustrate four example image quality metrics that may be used to measure image quality. Peak signal-to-noise ratio (PSNR) is the most widely used image quality metric in image processing and image compression and an example equation that adjusts or adapts the attenuator shown in FIG. 4.

FIG. 11 illustrates an example block diagram of a signal statistics measurement system based on attenuator ATTEN and gain 1/ATTEN, in accordance with a preferred embodiment.

FIG. 12 illustrates a hybrid access encoder with a feedback loop that adjusts the attenuation value ATTEN operating in a hybrid feedback mode, in accordance with a preferred embodiment.

FIGS. 13A, 13B, 13C (collectively “FIG. 13” herein) illustrate color space conversion between a Bayer matrix input, such as from an image sensor, to a standard red/green/blue (RGB) format and color space conversion from RGB format to YCbCr 4:2:2 format, or to YCbCr 4:2:0 format.

FIGS. 14A, 14B (collectively “FIG. 14” herein) illustrate two-pass and N-pass methods that improve compression performance (greater image compression ratio or improved image quality), when compared with one-pass methods, in accordance with a preferred embodiment.

### DETAILED DESCRIPTION

The present specification describes multiple techniques for performing low complexity encoding of reference frames in a user-programmable way that allows multiple tradeoffs between the resulting bit rate and corresponding image quality of the decoded reference frame, or of decoded MacBlks within each reference frame. As reference frames are written to DDR memory, they are encoded according to user-selected parameters, such as the desired encoding ratio or the desired image quality. One particular implementation of the present invention allows users to specify the desired (target) value of an image quality parameter from among one or more image quality metrics, such as peak signal-to-noise ratio (PSNR), Structural Similarity (SSIM), Pearson's Correlation Coefficient (PCC), or signal-to-noise ratio (SNR). The present invention thus allows users to specify a minimum image quality level, rather than the more common specification of a desired encoded bit rate. As encoded MacBlks from reference frame are read from the memory IC, they are decoded according to parameters selected or calculated during prior MacBlk encoding.

Many of the functional units described in the specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical of logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Embodiments of the access encoder and access decoder described herein may encompass a variety of computing architectures that represent image data using a numerical representation. Image data may include both integer data of various bit widths, such as 8 bits, 10 bits, 16 bits, etc. and floating-point data of various bit widths, such as 32 bits or 64 bits, etc. The image data may be generated by a variety of applications and the computing architectures may be general purpose or specialized for particular applications. The image data may result from detected data from a physical process, image data created by computer simulation or intermediate values of data processing, either for eventual display on a display device or monitor, or simply for intermediate storage. For example, the numerical data may arise from image sensor signals that are converted by an analog to digital converter (ADC) in an image sensor to digital form, where the digital samples are typically represented in an integer format. Common color representations of image pixels include RGB (Red, Green, and Blue) and YUV (brightness/chroma1/chroma2). Image data may be captured and/or stored in a planar format (e.g. for RGB, all R components, followed by all G components, followed by all B components) or in interleaved format (e.g. a sequence of {R, G, B} triplets).

An image frame has horizontal and vertical dimensions H_DIM and V_DIM, respectively, as well as a number of color planes N_COLORS (typically 3 [RGB or YUV] or 4 [RGBA or YUVA], including an alpha channel). H_DIM can vary between 240 and 2160, while V_DIM can vary between 320 and 3840, with typical H_DIM and V_DIM values of 1080 and 1920, respectively, for a 1080p image or video frame. A single 1080p frame requires at least 1080×1920×3 Bytes=6 MByte of storage, when each color component is stored using 8 bits (a Byte). Video frame rates typically vary between 10 and 120 frames per second, with a typical frame rate of 30 frames per second (fps). Industry standard video compression algorithms called H.264 and H.265 achieve compression ratios between 10:1 and 50:1 by exploiting the correlation between pixels in MacBlks of successive frames, or between MacBlks of the same frame. Compression or decompression processing using industry-standard codecs requires storage of the last N frames prior to the frame that is currently being processed. These prior frames are stored in off-chip memory and are called reference frames. The access encoder described below accelerates access to the reference frame between a processor and off-chip memory to reduce the required bandwidth and capacity for MacBlks in reference frame.

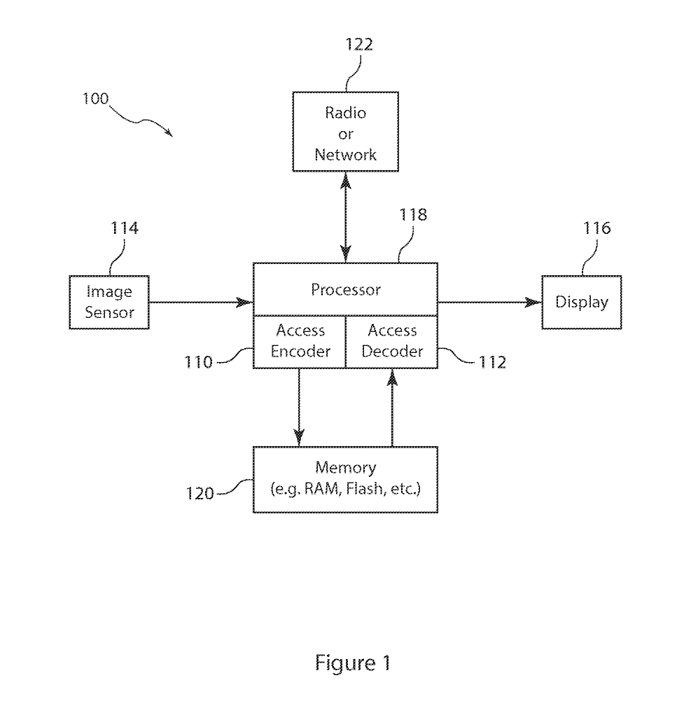

FIG. 1 is a block diagram of a computing system 100 that captures, processes, stores, and displays digital image data, including an access encoder 110 and access decoder 112, in accordance with a preferred embodiment. An image sensor 114 provides pixels to a processor 118, typically raster by raster, for each captured image frame. A display 116 or monitor receives pixels from a processor, typically raster by raster, for each image frame to be displayed. The processor 118 responds to user inputs (not shown) and orchestrates the capture, processing, storage, and display of image data. A memory 120 is used to store reference frame and other intermediate data and meta-data (such as date and time of capture, color format, etc.) and may optionally also be used to store a frame buffer of image data just prior to image display, or just after image capture. An optional radio or network interface 122 allows the processor 118 to transmit or to receive other image data in any format from other sources such as the Internet, using wired or wireless technology. The access encoder 110 encodes the image data for storage in the memory 120 and generates supplemental information for the encoded image data. The image data to be encoded may be in raster format such as when received by the image sensor 114, or in macroblock format, such as unencoded video frame data. The access encoder 110 generates supplemental information for the encoded image data. The processor 118 may use the supplemental information to access the encoded image data in raster format or in macroblock format, as needed for the application processing. The access decoder 112 decodes the encoded image data and provides the decoded image data in raster or macroblock format. The access decoder 112 may provide the decoded image data in raster format, as needed for display, or in macroblock format, as needed for macroblock-based video encoding operations.

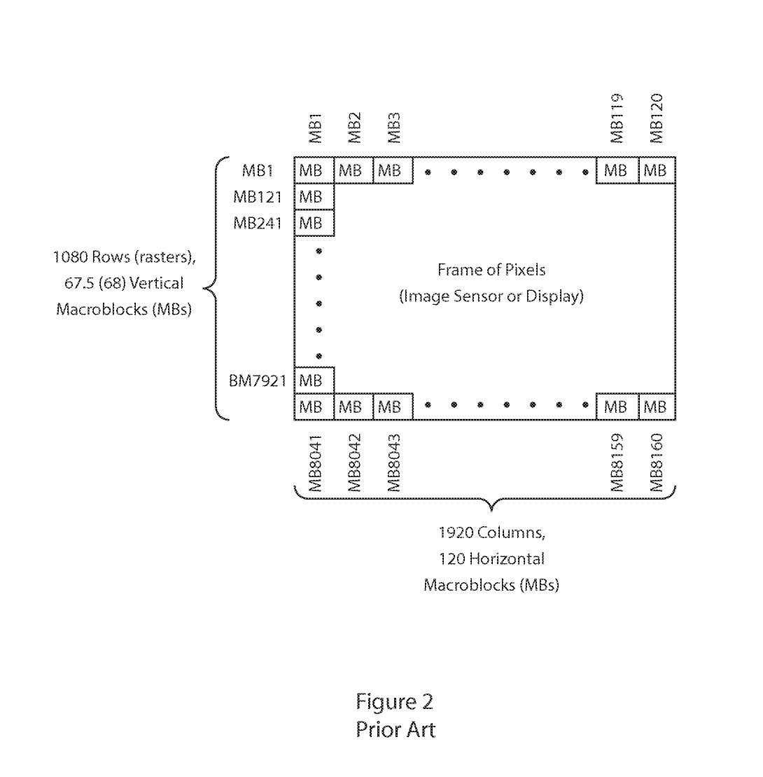

FIG. 2 illustrates the organization of an example of a 1080p image frame having 1080 rows (rasters) and 1920 pixels per row (raster). FIG. 2 also shows how macroblocks of 16×16 pixels are overlaid on the image data, creating 120 horizontal MacBlks (per 16 vertical rasters) and 68 vertical MacBlks (per 16 horizontal rasters), for a total of 8,160 MacBlks per 1080p frame.

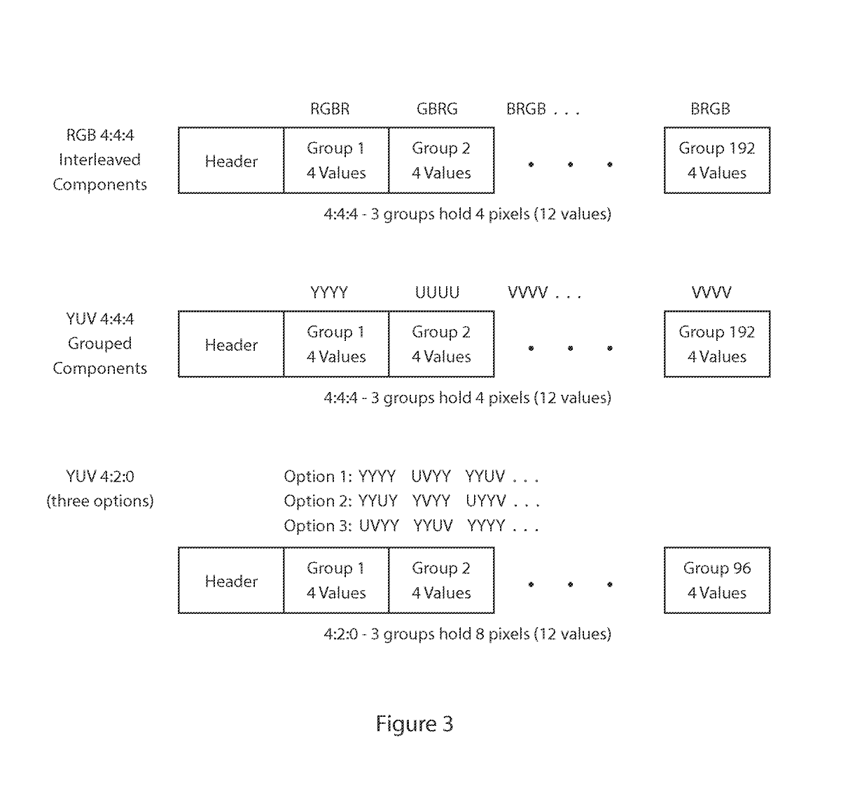

FIG. 3 illustrates several examples of packing pixel data into a packet. The access encoder 110 may apply the techniques described in the '511 application and the '803 application. The '511 application describes algorithms for compressing and storing image data. The '803 patent describes block floating point encoding, that compresses and groups four mantissas (differences) at a time. The access encoder 110 may compress the image data by computing first or second order differences (derivatives) between sequences of samples of the same color components, as described in the '511 application. The access encoder 110 may apply block floating point encoding to the difference values, as described in the '803 patent. The block floating point encoder groups resulting difference values and finds the maximum exponent value for each group. The number of samples in the encoding groups is preferably four. The maximum exponent corresponds to the place value (base 2) of the maximum sample in the group. The maximum exponent values for a sequence of the groups are encoded by joint exponent encoding. The mantissas in the encoding group are reduced to have the number of bits indicated by the maximum exponent value for the group. The groups may contain different numbers of bits representing the encoded samples. FIG. 3 labels such grouped components “Group 1, Group 2,” etc. The access encoder 110 allows flexible ordering of the groups of compressed color components. In the examples of FIG. 3, three groups of 4 encoded components can store image components in any of the following ways:
a. Example 1, RGB 4:4:4: {RGBR}, {GBRG}, {BRGB}
b. Example 2, YUV 4:4:4: {YYYY}, {UUUU}, {VVVV}
c. Example 3, YUV 4:2:0: {YYYY}, {UVYY}, {YYUV}, Option 1
d. Example 4, YUV 4:2:0: {YYUY}, {YVYY}, {UYYV}, Option 2
e. Example 5, YUV 4:2:0: {UVYY}, {YYUV}, {YYYY}, Option 3

The access encoder 110 may form a packet containing a number of the groups of encoded data for all the color components of the pixels in one macroblock. For RGB 4:4:4 and YUV 4:4:4, the number of groups of encoded data is preferably 192. For YUV 4:2:0, the number of groups is preferably 96. The packets may include a header that contains parameters used by the access decoder 112 for decoding the groups of encoded data.

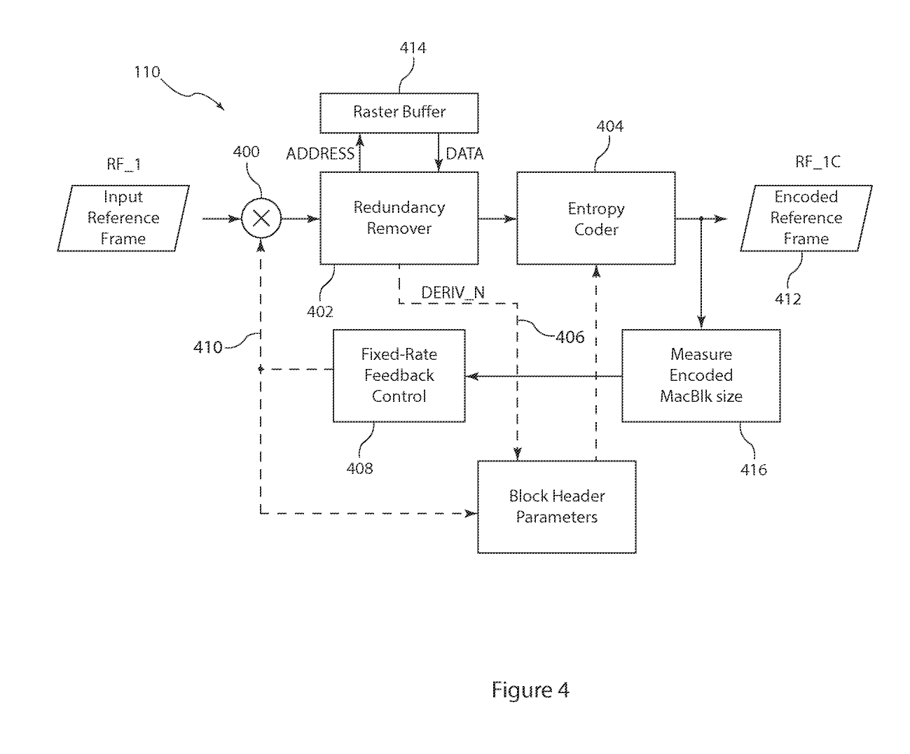

FIG. 4 is a block diagram of the access encoder 110, in accordance with a preferred embodiment. Aspects of these access encoder 110 components are described in the '533 patent, the '205 application, and the '511 application. The access encoder 110 includes an attenuator 400, a redundancy remover 402, and an entropy coder 404. A preferred embodiment of the entropy encoder 404 comprises a block exponent encoder and joint exponent encoder, as described in the '803 patent. The redundancy remover 402 may store one or more previous rasters (rows of pixels) in a raster buffer 414. The raster buffer 414 enables the redundancy remover 402 to select from among three alternative image component streams:
a. The original image components (such as RGB or YUV),
b. The first difference between corresponding image components, where the variable “i” indicates the current image component along a row or raster, such as:
   1. R(i)−R(i−1), followed by
   2. G(i)−G(i−1), followed by
   3. B(i)−B(i−1);
      or
   4. Y(i)−Y(i−1), followed by
   5. U(i)−U(i−1), followed by
   6. V(i)−V(i−1)
c. The difference between corresponding image components from the previous row (raster), where the variable i indicates the current image component along a row or raster, and the variable j indicates the current row or raster number, such as:
   1. R(i,j)−R(i,j−1), followed by
   2. G(I,j)−G(i,j−1), followed by
   3. B(i,j)−B(i,j−1);
      or
   4. Y(i,j)−Y(i,j−1), followed by
   5. U(i,j)−U(i,j−1), followed by
   6. V(i,j)−V(i,j−1).

During the encoding of the current MacBlk, the redundancy remover 402 determines which of these three streams will use the fewest bits, i.e. will compress the most. That stream is selected as the “best derivative” for the next encoded MacBlk. The “best derivative” selection is encoded in the encoded MacBlk's header as indicated by the DERIV_N parameter 406 in FIG. 4. The entropy coder 404 receives the selected derivative samples from the redundancy remover 402 and applies block floating point encoding and joint exponent encoding to the selected derivative samples. The block floating point encoding determines the maximum exponent values of groups of the derivative samples. The maximum exponent value corresponds to the place value (base 2) of the maximum valued sample in the group. Joint exponent encoding is applied to the maximum exponents for a sequence of groups to form exponent tokens. The mantissas of the derivative samples in the group are represented by a reduced number of bits based on the maximum exponent value for the group. The sign extension bits of the mantissas for two's complement representations or leading zeros for sign-magnitude representations are removed to reduce the number of bits to represent the encoded mantissas. The parameters of the encoded MacBlk may be stored in a header. The entropy coder may combine the header with the exponent tokens and encoded mantissa groups to create an encoded MacBlk. To support fixed-rate encoding, in which a user can specify a desired encoding rate, the access encoder 110 includes a block to measure the encoded MacBlk size 416 for each encoded MacBlk. A fixed-rate feedback control block 408 uses the encoded MacBlk size 416 to adjust the attenuator setting (ATTEN) 410. More attenuation (smaller ATTEN value) will reduce the magnitudes of all three candidate streams provided to the redundancy remover 402, and thus will increase the encoding (compression) ratio achieved by the access encoder 110 of FIG. 4. Averaged over several encoded MacBlks, the fixed-rate feedback control may achieve the user-specified encoding rate. The access encoder 110 generates one or more encoded MacBlks. A number of encoded MacBlks comprise encoded reference frame RF_{—}1C 412.

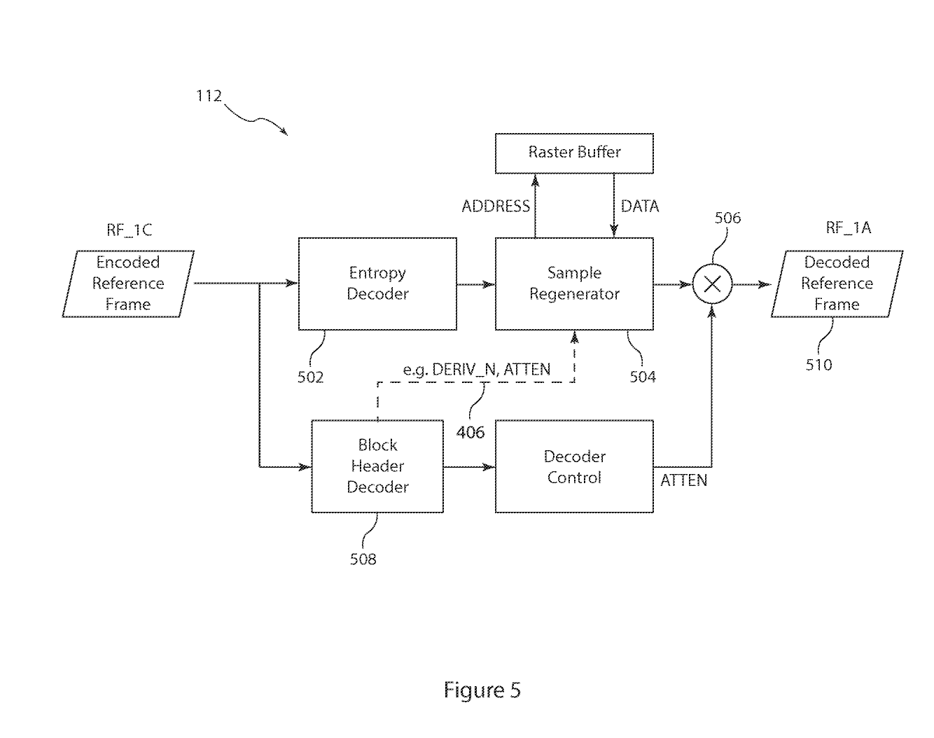

FIG. 5 is a block diagram of an access decoder 112, in accordance with a preferred embodiment. Aspects of these decoder components are described in the '533 patent, the '205 application, and the '511 application. The access decoder 112 preferably includes an entropy decoder 502, a sample regenerator 504, and a gain module (multiplier) 506. The entropy decoder 502 preferably comprises block floating point decoder and joint exponent decoder (JED), further described in the '803 patent. A state machine (not shown in FIG. 5) in the access decoder 112 separates the encoded MacBlks into header and payload sections, and passes the header sections to a block header decoder 508, which decodes MacBlk header parameters such as DERIV_N and ATTEN. The sample regenerator 504 inverts the operations of the redundancy remover 402 in accordance with the parameter DERIV_N provided in the encoded macroblock's header. For example, when the redundancy remover 402 selected original image components the sample regenerator 504 provides decoded image components. For another example, when the redundancy remover 402 selected image component pixel differences or image component raster/row differences, the sample regenerator 504 would integrate, or add, the pixel differences or raster/row differences, respectively, to produce decoded image components. The sample regenerator 504 stores the decoded image components from one or more previous rasters (rows of pixels) in a raster buffer 414. These decoded image components are used when the MacBlks was encoded using the previous row/raster's image components by the access encoder 110, as described with respect to FIG. 4. The inverse of the parameter ATTEN is used by the gain module (multiplier) 506 of FIG. 5 to increase the magnitude of regenerated samples from the sample regenerator block 504. The access decoder 112 generates one or more decoded MacBlks. A number of decoded MacBlks comprise a decoded reference frame RF_{—}1A 510 as shown in FIG. 5. When the access encoder 110 operates in a lossless mode, the decoded MacBlks of RF_{—}1A will be identical to MacBlks of the input reference frame RF_{—}1. When the access encoder 110 operates in a lossy mode, the decoded MacBlks of RF_{—}1A will approximate the MacBlks of the input reference frame RF_{—}1 418. In a preferred embodiment of the lossy mode, the difference between the approximated MacBlks and the original MacBlks is selected or controlled by a user. The larger the encoding ratio the larger the difference between the approximated and original (input) MacBlks, but also the greater the savings in power consumption and the greater the battery life of a mobile device that utilizes the flexible, adaptive, user-controlled access encoder/decoder.

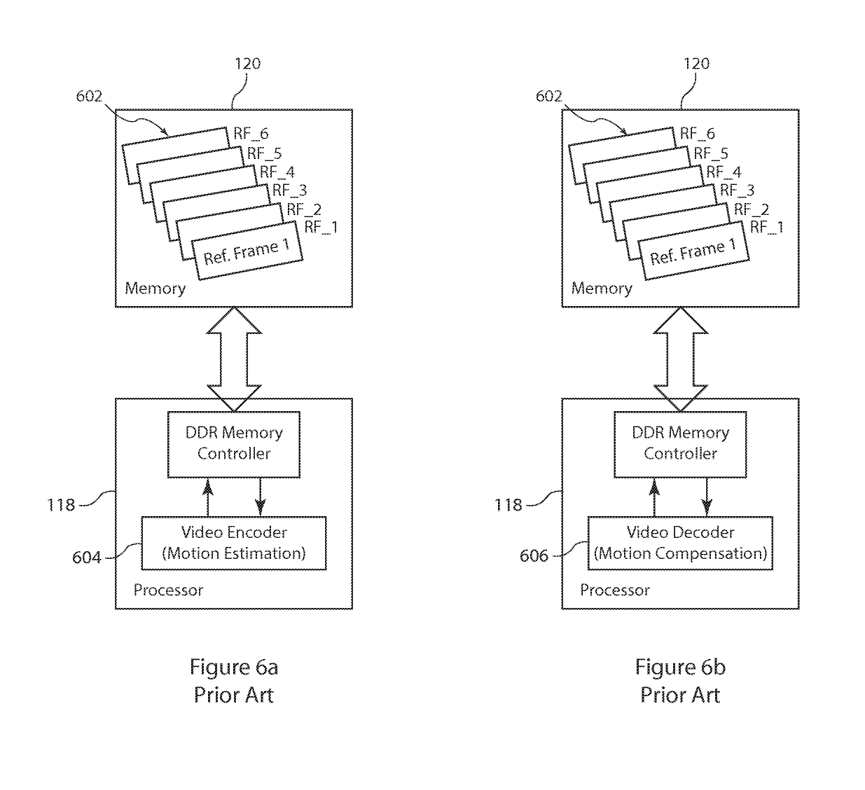

FIGS. 6a and 6b illustrate examples of macroblock-based video encoding and decoding algorithms, such as MPEG2, H.264, and H.265 (HEVC) that use one or more reference frames stored in a memory 120 for encoding a current frame of pixels. The macroblock-based video encoding algorithms have previously encoded the reference frames, decoded the encoded reference frames and stored the previously decoded reference frames RF_{—}1 to RF_{—}6 602 for use in motion estimation calculations for encoding the current frame. FIG. 6a illustrates an example of a video encoder where previously decoded reference frames are stored in a memory 120. For this example, six previously decoded reference frames RF_{—}1 to RF_{—}6 602 are stored in the memory 120 in uncompressed (unencoded) form, in formats such as RGB or YUV 4:2:0. RF_{—}1 is the reference frame immediately preceding the current frame being decoded. The video encoder's processor may access one or more macroblocks in any of the previously decoded reference frames RF_{—}1 thru RF_{—}6 602 during the motion estimation process to identify a similar macroblock to the current macroblock in the frame currently being encoded. A reference frame to that most similar macroblock in the one or more reference frame RF_{—}1 thru RF_{—}6 in this example is then stored in the encoded video stream as a “motion vector.” The motion vector identifies the most similar prior macroblock in the reference frames RF_{—}1 thru RF_{—}6 602, possibly interpolated to the nearest ½ or ¼-pel location. As shown in FIG. 6b, the video decoder stores the same previously decoded reference frames RF_{—}1 thru RF_{—}6 602 during motion compensation as did the video encoder 604 during motion estimation. The video decoder 606 retrieves the macroblock in the previously decoded reference frame corresponding to the motion vector. The video decoder 606 optionally interpolates the most-similar macroblock's pixels by ½ or ¼-pel, as did the video encoder 604. In this manner, both the video encoder 604 shown in FIG. 6a and the video decoder 604 shown in FIG. 6b reference the same reference frames while encoding and decoding a sequence of images of a video.

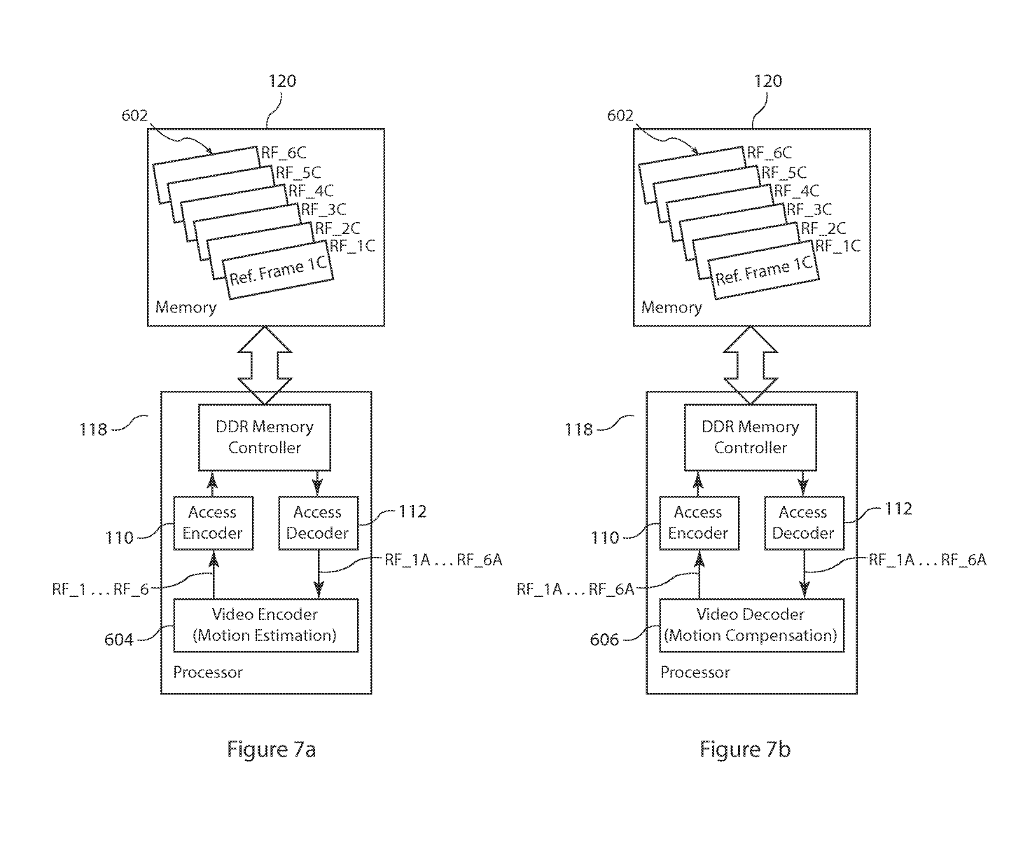

FIGS. 7a and 7b illustrate examples of systems in which a video encoder 704 and a video decoder 706 include an access encoder 110 and an access decoder 112. FIG. 7a illustrates a video encoder system that includes an access encoder 110 and an access decoder 112. The access encoder 110 encodes MacBlks of reference frame to be used by video encoder 704, which stores encoded (compressed) MacBlks. The macroblock-based video encoding algorithms have previously encoded the reference frames, decoded the encoded reference frames and stored the previously decoded reference frames RF_{—}1 to RF_{—}6 702 for use in motion estimation calculations for encoding the current frame. The access decoder 112 retrieves and decodes encoded MacBlks to provide decoded (decompressed) MacBlks from reference frame during the video encoder's 704 Motion Estimation (ME) process.

FIG. 7b illustrates a video decoder system that includes an access encoder 110 and an access decoder 112. The access encoder 110 encodes MacBlks of reference frames to be used by the video decoder 706, which stores the encoded (compressed) MacBlks. The access decoder 112 retrieves and decodes the encoded MacBlks to provide decoded (decompressed) MacBlks from reference frames during the video decoder's 706 Motion Compensation (MC) process. When the settings (lossless/lossy mode setting, and for lossy encoding, the lossy encoding, or compression, rate) of the access encoder/decoder pair are identical in the video encoder 704 (FIG. 7a) and video decoder 706 (FIG. 7b), the decoded MacBlks from approximated reference frames RF_{—}1A thru RF_{—}6A 702 in this example will be identical in both the video encoder 704 (FIG. 7a) and the video decoder 706 (FIG. 7b). Decoded MacBlks in both the video encoder 704 (FIG. 7a) and video decoder 706 (FIG. 7b) will be identical, regardless of the operating mode (lossless or lossy) and the encoding (compression) rate for the lossy mode. Thus, the video encoder system and video decoder system can use the access encoder/decoder in the lossy or lossless mode. These modes and the encoding rate (compression ratio) may be selectable by the user via a user interface.

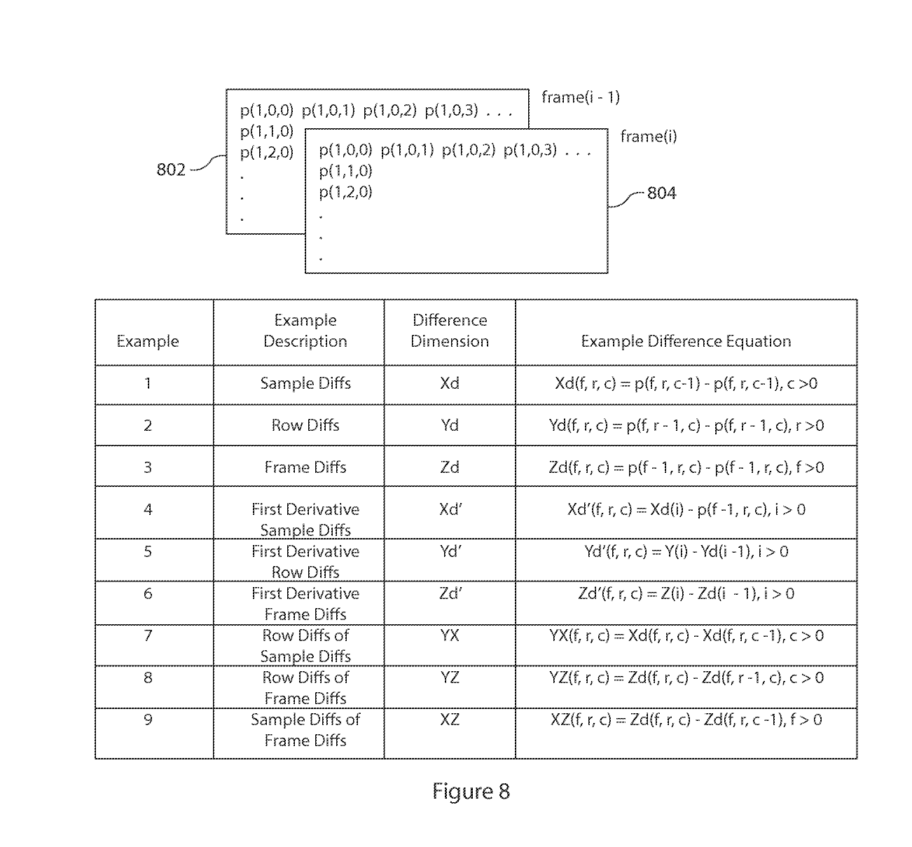

FIG. 8 illustrates two video frames frame(i) 802 and frame(i−1) 804, where frame(i) 802 follows frame(i−1) 804. Each frame is comprised of pixels p(f, r, c) having a frame number f, row or raster number r, and column c. For example, p(0,1,3) is from frame 0, row or raster 1, and column 3. The table in FIG. 8 illustrates examples of how nine alternative derivatives (differences) can be generated. Multiple differences are useful in compression algorithms because some difference sequences will compress better than others. Given multiple difference sequences, a compression algorithm can choose the best-compressing sequence to pack. Example 1 generates sample differences along the x (horizontal, raster, or row) dimension. Example 2 generates row differences between successive rasters or rows in the y direction. Example 3 generates frame differences between corresponding pixels in successive frames, in the z direction. Example 4 generates the first derivative of sample differences. Example 5 generates the first derivative of row differences. Example 6 generates the first derivative of frame differences. Example 7 generates row differences of sample differences. Example 8 generates row differences of frame differences. Example 9 generates sample differences of frame differences. Other differences can be generated in a similar manner.

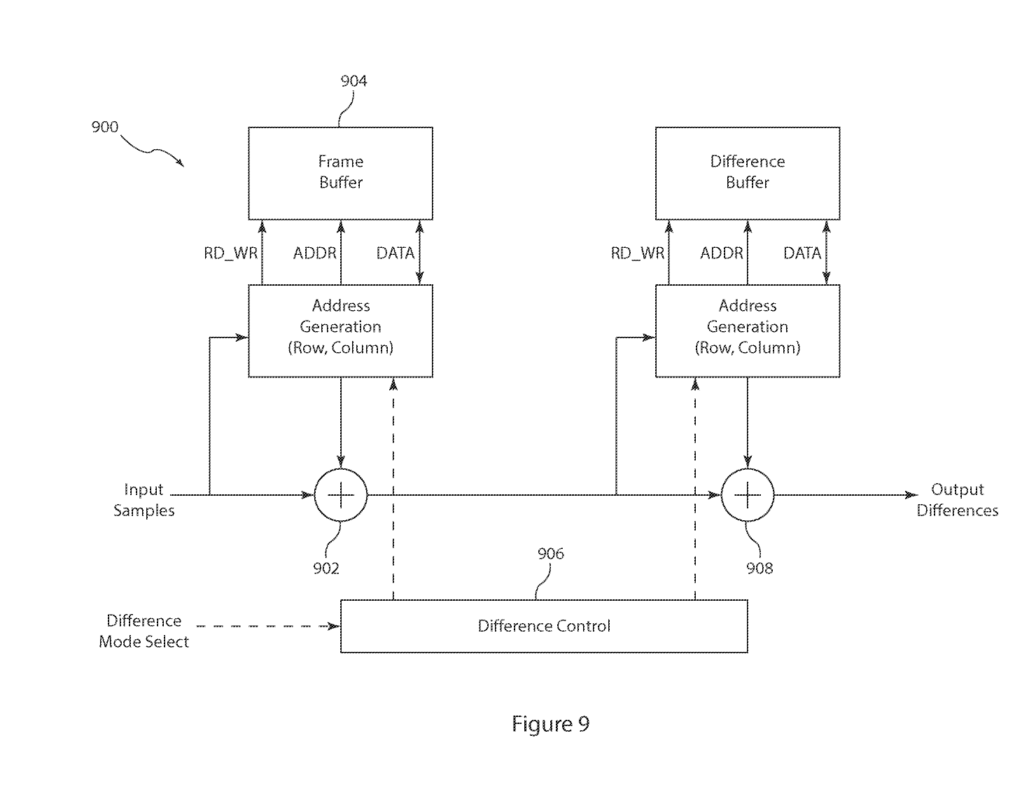

FIG. 9 illustrates a block diagram of a programmable difference engine 900 that could be implemented in software or hardware to create the example differences described with respect to FIG. 8. FIG. 9 illustrates how the input samples are input to an adder 902 that subtracts a correlated sample whose location in the frame buffer 904 is specified by the difference controller 906. The previous sample could be chosen to represent the previous sample (implementing sample differences), the corresponding pixel from the previous row or raster (implementing row or raster differences), or the corresponding pixel from the previous frame (implementing frame differences). The second adder 908 in FIG. 9 generates an additional difference sample, such as the first derivative (difference) of the sample difference, row difference, or frame difference generated by the first adder 902. In this manner, the second adder 908 can generate the first derivative of the sample, row, or frame difference (Examples differences 4, 5, and 6 in FIG. 8). The user, or some external software process that monitors compression ratio, compression quality, or other system parameter, sets the difference mode selection input to the difference controller.

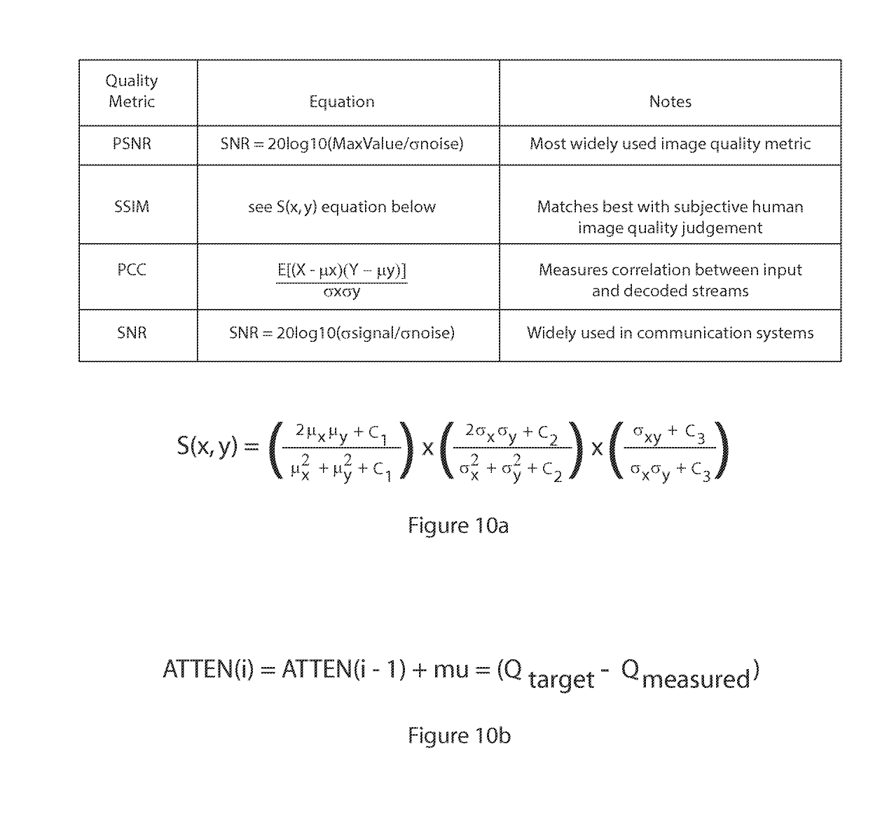

FIG. 10a illustrates four example image quality metrics that may be used to measure image quality. Peak signal-to-noise ratio (PSNR) is the most widely used image quality metric in image processing and image compression. Structural Similarity (SSIM) has the best correlation to subjective human image quality judgments. Pearson's correlation coefficient (PCC) provides a quantitative metric of the similarity (correlation) between two numerical sequences X and Y. Signal-to-noise ratio (SNR) is a logarithmic quality metric that measures the ratio of signal power to noise power. The equations in FIG. 10a are merely examples of quality metrics; other equations and quality metrics could be used for other applications outside of imaging, and quality metrics other than those shown in FIG. 10a could be used for imaging.

FIG. 10b illustrates an example equation that adjusts or adapts the attenuator shown in FIG. 4, depending on target image quality Q_{target} and measured image quality Q_{measured}. The equation shown in FIG. 10b could be implemented in the fixed-rate feedback control block shown in FIG. 4. The equation shown in FIG. 10b adapts at a rate controlled by the parameter mu. A smaller mu value causes slower adaptation, while a larger mu factor causes faster adaptation. As Q_{target} approaches Q_{measured}, changes to the attenuator become smaller.

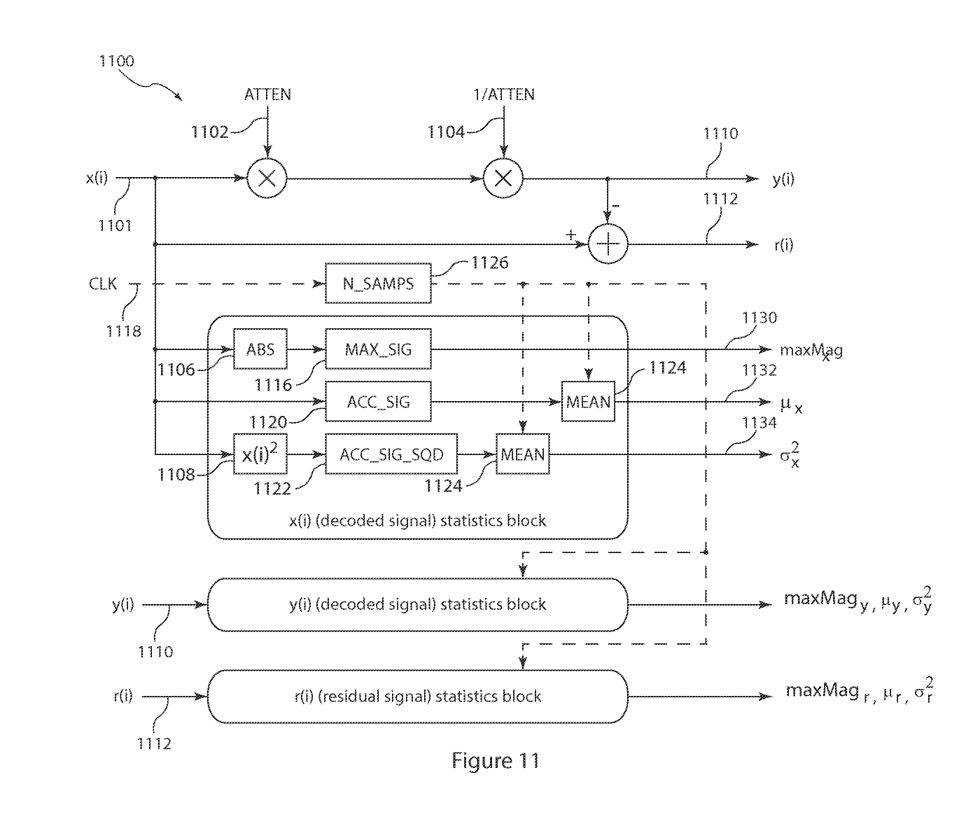

FIG. 11 illustrates an example block diagram of a signal statistics measurement system based on attenuator ATTEN 1102 and gain 1/ATTEN 1104. Input samples x(i) 1101 are first attenuated by ATTEN 1102 and are then amplified by 1/ATTEN 1104, generating re-scaled sample y(i) 1110. Residual r(i)=x(i)−y(i) 1112; residual 1112 may also be referred to as the “noise” introduced by the attenuation and subsequent amplification process. The various blocks shown in FIG. 11 can generate the measured variables used in the various image quality equations of FIG. 10, such as μₓ, σ_{y}², etc. ABS 1106 indicates absolute value while x² 1108 indicates the squaring operation. MAX_SIG 1116 compares and updates the maximum signal magnitude. At each clock CLK 1118, ACC_SIG 1120 adds the value present at its input with the accumulator's previous contents. At each clock CLK 1118, ACC_SIG_SQD 1122 adds the squared value present at its input with the accumulator's previous contents. MEAN 1124 calculates a mean value by dividing an input value S (sum) by sample count N 1126. Statistical outputs for each input sample stream include maxMag 1130, μ 1132, and σ²1134. In FIG. 11, three statistics-collection blocks measure the statistics of three samples streams x(i) 1101, y(i) 1110, and r(i) 1112. These statistical values for x, y, and r can be used to create the quality metrics described with respect to FIG. 10.

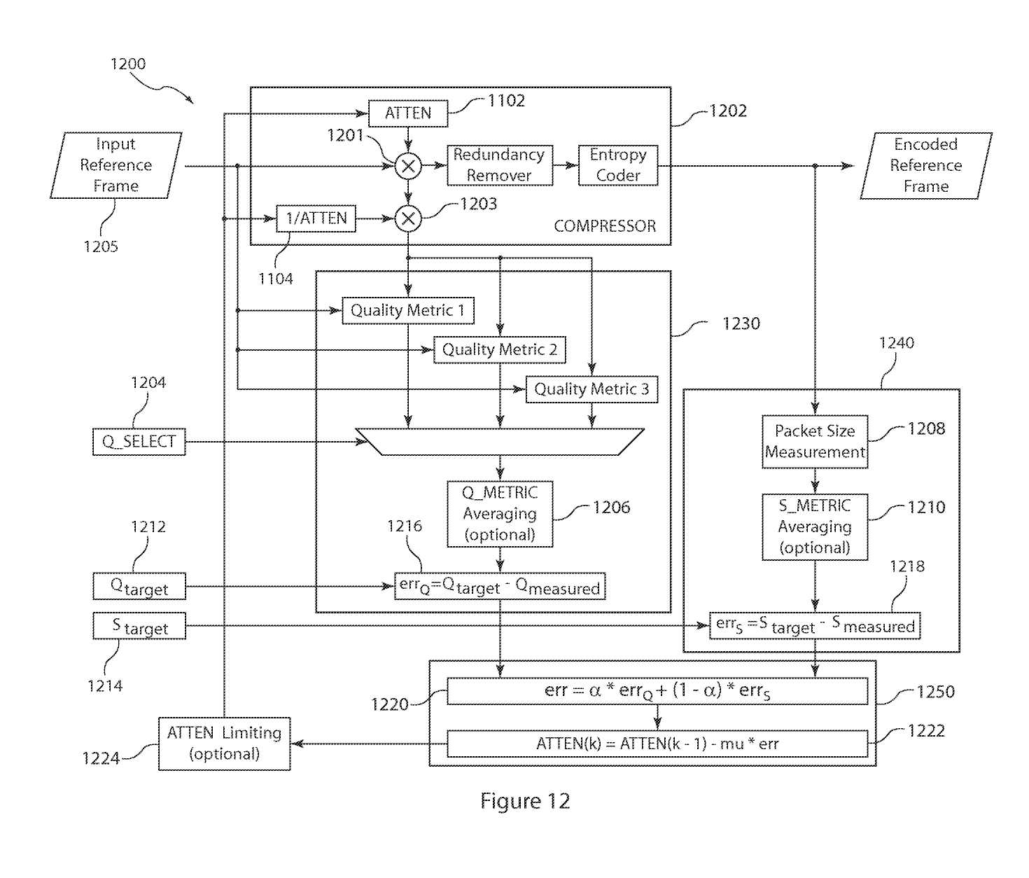

FIG. 12 illustrates a hybrid access encoder 1200 with a feedback loop that adjusts the attenuation value ATTEN 1102 operating in a hybrid feedback mode. In the discussion with respect to FIG. 12, “hybrid” refers to feedback that combines aspects of both fixed-rate and fixed-quality compression modes. Under many circumstances, compression users will be satisfied to be able to specify the target compression ratio (fixed rate mode) or the target signal quality of the decompressed (decoded) signal. However, in some cases it would be valuable to combine aspects of both fixed-rate and fixed-quality compression modes in the feedback loop that adjusts the attenuator setting. In FIG. 12, input reference frames 1205 are compressed by a compressor 1202, which includes a first multiplier using ATTEN 1102 as its multiplier value, and a second multiplier 1203 using 1/ATTEN 1104 as its multiplier value.

FIG. 12 illustrates an example using three quality metrics in a control module control module 1230 that are generated using the decompressed reference frames, the input reference frames 1205, and/or the difference between the input and the decompressed reference frames, in accordance with a preferred embodiment. The Q_SELECT control element 1204 determines which of the quality metrics are used as input to the optional fixed-quality Q_METRIC averaging module 1206. A fixed-rate control module 1240 has a packet size measurement block 1208 that measures packet size S. The packet size measurement is used as an input to an optional S_METRIC averaging block 1210. Averaging the quality and compressed packet size metrics smoothes the instantaneous quality and packet size metrics which leads to smoother feedback loop performance. The averaging method can be simple (“average the last N samples with equal weighting”) or more complex (“apply finite impulse response [FIR] filter coefficients to the previous N measurements, to smooth the quality and/or size metrics”). Given a target quality metric Q_{target} 1212 and a target compressed packet size metric S_{target} 1214, a quality error err_{Q} 1216 and size error err_{S} 1218 can be created.

An attenuation parameter module 1250 calculates an error parameter in an error calculation module 1220 which is then used to calculate the hybrid attenuation parameter in an attenuation calculation module 1222. The parameter alpha (α) determines how err_{Q} 1216 and err_{S} 1218 parameters are blended (hybridized) to create a hybrid error parameter “err” 1220. Finally, the “err” term 1220 is multiplied by the adaptive feedback rate control parameter mu (μ) to update the ATTEN value 1222 that is subsequently applied to new input samples being compressed. An optional ATTEN_LIMITING block 1224 may restrict the minimum and maximum ATTEN value to ATTEN_MIN and ATTEN_MAX, respectively.

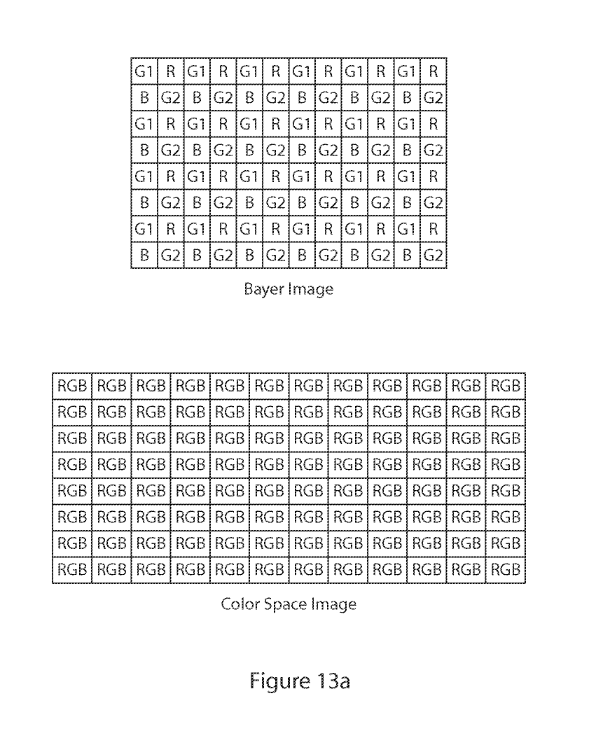

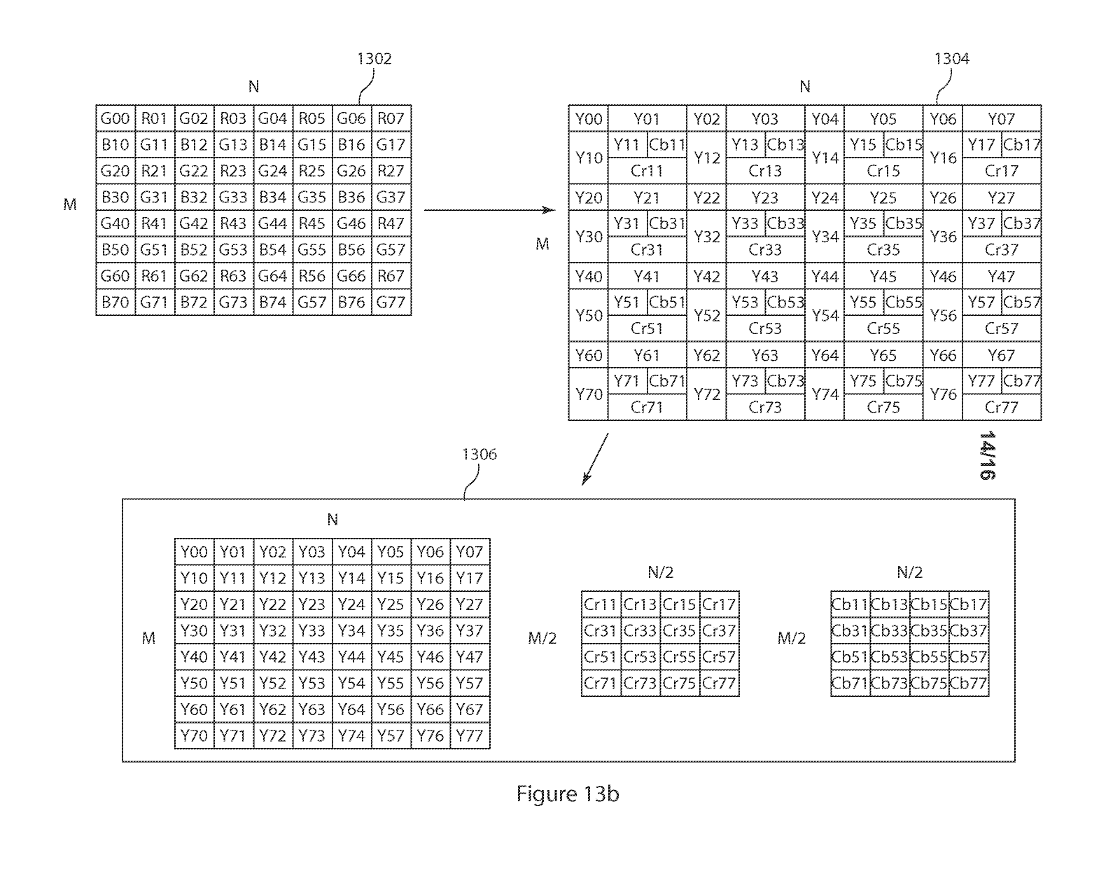

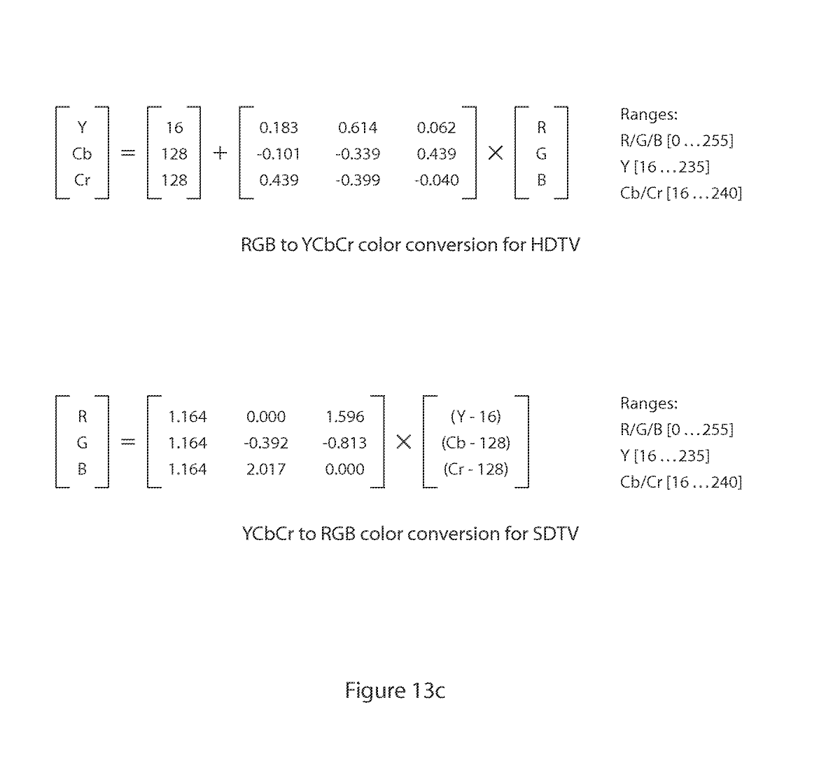

FIG. 13a illustrates color space conversion between a Bayer matrix input, such as from an image sensor, to a standard red/green/blue (RGB) format. Bayer matrix samples are commonly generated by image sensors, while RGB format is preferred for image processing and subsequent image displays and monitors. FIG. 13b illustrates color space conversion from RGB format 1302 to YCbCr 4:2:2 format 1304, or to YCbCr 4:2:0 format 1306 wherein the total size equals (M×N)/2+(M×N)/4+(M×N)·4=3.2×(M×N). If each pixel location is 8 bits, an M×N image can be said to be 3/2×8(M×N) bits or 12 bits of (M×N). Various matrix coefficients are used to perform these conversions. The conversion coefficients are often specified by image processing standards bodies such as ISO, CCIR, and SMPTE. FIG. 13c provides examples of coefficients used during RGB-to-YCbCr conversion (upper image in FIG. 13c) and YCbCr-to-RGB conversion (lower image in FIG. 13c).

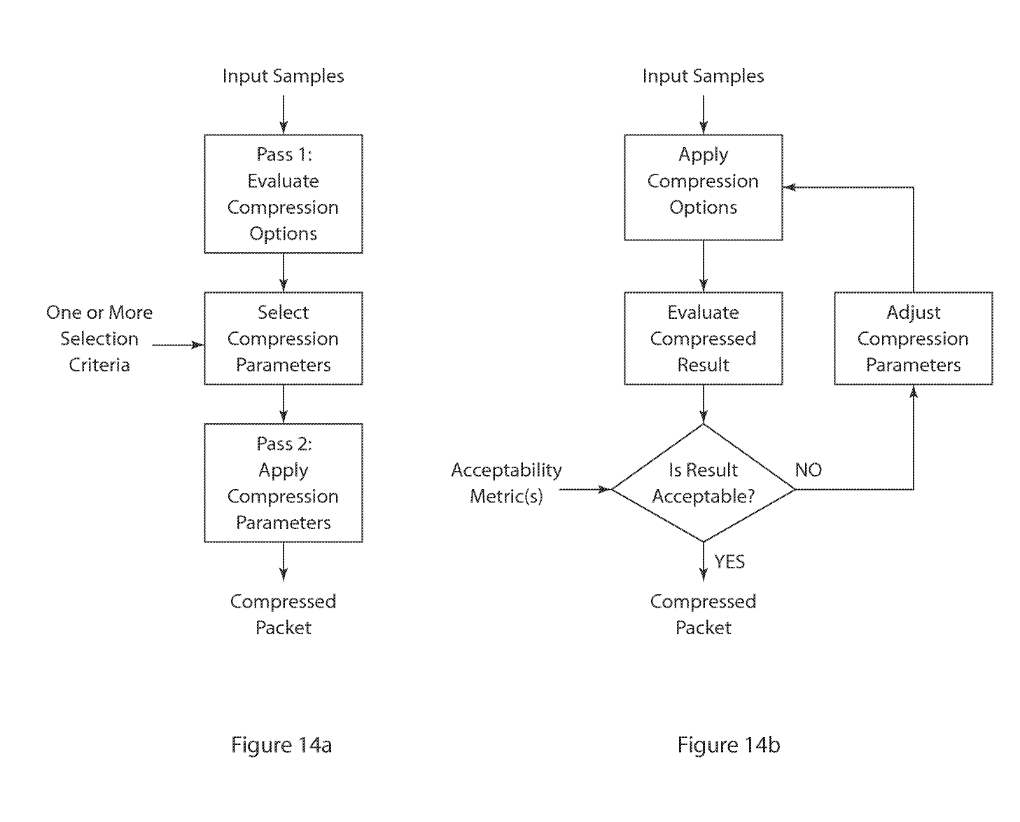

FIG. 14 illustrates two-pass and N-pass methods that improve compression performance (greater image compression ratio or improved image quality), when compared with one-pass methods. FIG. 14a illustrates that a first pass of an image compression algorithm can evaluate a plurality of image compression options, including parameter settings, algorithm choices, or a combination of parameter settings and algorithm choices. After a first pass, the appropriate compression parameters and/or algorithms are selected according to certain selection criteria that are compared to the compression results of, or options from, the first pass. The selection criteria may be specified by a user or may be automatically generated by software or hardware that examine the compression results (compression ratio), decompressed signal quality, or a combination thereof. During a second pass, the selected compression parameters and/or algorithm choices are applied to the input data and generate compressed packets. FIG. 14b illustrates an example of an N-pass compression loop, where input samples are compressed according to various compression parameters and algorithms. After each pass, compressed results (possibly including the decompressed results) are evaluated by measuring certain criteria, including decompressed sample quality, compressed size or compression ratio, and/or other statistical metrics to determine whether the resulting compressed and/or decompressed result is acceptable, according to the metrics' performance when compared to one or more acceptability metrics. If the results are not acceptable, one or more compression parameters are adjusted and an additional compression pass is performed. The adjustment of the compression parameters may include adjustment of an attenuation parameter, a compression algorithm selection, a compressed packet size (number of input samples per compressed packet), or other parameter adjustments that modify the compression ratio, the quality of decompressed samples (as measured by one or more sample quality metrics), or other desired compression outcome.

The access encoder can reduce the amount of DDR memory required to store reference frame in image compression applications such as H.264 and similar algorithms that encode image frames using MacBlks, as well as the time required to access the reference frame's pixels. The access encoder can also reduce the amount of memory required to capture image sensor frames and to store display frames. The access encoder provides a flexible, user-controllable method of reducing both DDR memory capacity and memory bandwidth required for common image capture, processing, storage, and display functions in a flexible, user-controlled or automatically-controlled way. Speed and latency of reference frame encoding can be modified by varying the number of pipeline stages in the combinatorial logic for the flexible encoding and decoding functions. Other implementations of the present invention may use dedicated input and output registers in addition to, or instead of, the memory and registers described in the examples of the present specification.

A variety of implementation alternatives exist for the embodiments of the access encoder and reference frame decoder, such as implementation in a microprocessor, graphics processor, digital signal processor, field-programmable gate array (FPGA), application-specific integrated circuit (ASIC), or system-on-chip (SoC). The implementations can include logic to perform the functions and/or processes described herein, where the logic can include dedicated logic circuits, configurable logic such as field programmable logic array FPGA blocks, configured to perform the functions, general purpose processors or digital signal processors that are programmed to perform the functions, and various combinations thereof.

The access encoder and access decoder operations can be implemented in hardware, software or a combination of both, and incorporated in computing systems. The hardware implementations include ASIC, FPGA or an intellectual property (IP) block for a SoC. The access encoder's operations can be implemented in software or firmware on a programmable processor, such as a digital signal processor (DSP), microprocessor, microcontroller, multi-core CPU, or GPU.

In one embodiment for a programmable processor, programs including instructions for operations of the access encoder are provided in a library accessible to the processor. The library is accessed by a compiler, which links the application programs to the components of the library selected by the programmer. Access to the library by a compiler can be accomplished using a header file (for example, a file having a “.h” file name extension) that specifies the parameters for the library functions and corresponding library file (for example, a file having a “.lib” file name extension, a “.obj” file name extension for a Windows operating system, or a file having a “.so” file name extension for a Linux operating system) that use the parameters and implement the operations for the access encoder. The components linked by the compiler to applications to be run by the computer are stored, possibly as compiled object code, for execution as called by the application. In other embodiments, the library can include components that can be dynamically linked to applications, and such dynamically linkable components are stored in the computer system memory, possibly as compiled object code, for execution as called by the application. The linked or dynamically linkable components may comprise part of an application programming interface (API) that may include parameters for compression operations.

For implementation using FPGA circuits, the technology described here can include a memory storing a machine readable specification of logic that implements the access encoder, and a machine-readable specification of the access decoder logic, in the form of a configuration file for the FPGA block. For the systems shown in FIG. 1, optionally including additional components, the access encoder and access decoder may be described using computer aided design tools and expressed (or represented), as data and/or instructions embodied in various computer-readable media, in terms of their behavioral, register transfer, logic component, transistor, layout geometry, and/or other characteristics. A machine readable specification of logic that implements the access encoder and a machine-readable specification of the access encoder's functions can be implemented in the form of such behavioral, register transfer, logic component, transistor, layout geometry and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. A memory including computer-readable media in which such formatted data and/or instructions may be embodied include, but are not limited to, computer storage media in various forms (e.g., optical, magnetic or semiconductor storage media, whether independently distributed in that manner, or stored “in situ” in an operating system).

When received within a computer system via one or more computer-readable media, such data and/or instruction-based expressions of the above described circuits may be processed by a processing entity (e.g., one or more processors) within the computer system in conjunction with execution of one or more other computer programs including, without limitation, netlist generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A hybrid access encoder, comprising:
a compressor module, comprising:
an attenuator configured to receive an input sample and an attenuation parameter;
a gain module coupled to the attenuator and configured to receive a gain parameter and an output from the attenuator;
a redundancy remover coupled to the attenuator;
a entropy coder coupled to the redundancy remover; and
a feedback loop coupled to the compressor and configured to receive an output from the compressor, process the output, and return an attenuation parameter to the compressor.

2. The hybrid access encoder of claim 1, wherein the feedback loop comprises:
a fixed-quality control module coupled to the compressor and configured to receive a gain module output;
a fixed-rate control module coupled to the compressor and configured to receive an entropy coder output; and
an attenuation parameter module configured to receive the outputs from the fixed-rate control module and the fixed-quality control module and return the attenuation parameter to the compressor module.

3. The hybrid access encoder of claim 2, wherein the attenuation parameter module further comprises:
a error calculation module configured to receive outputs from the fixed-quality control module and the fixed-rate control module and to calculate an error parameter and provide the error parameter to the attenuation calculation parameter module.

4. The hybrid access encoder of claim 3, where the feedback loop comprises a plurality of signal quality metric modules configured to measure the quality of a decompressed image.

5. The hybrid access encoder of claim 4, where the signal quality metrics modules measure the quality comprising at least one of the following metrics:
a. a peak signal-to-noise (PSNR) metric;
b. a signal-to-noise ratio (SNR) metric;
c. a structural similarity (SSIM) metric; and,
d. a Pearson correlation coefficient (PCC) metric.

6. The image hybrid access encoder of claim 1, wherein the redundancy remover contains a plurality of filters each filter having filter coefficients.

7. The reference image compressor of claim 2, wherein the attenuation parameter module further comprises an error module that uses a combination of a fixed-quality metric and a fixed-rate metric to adjust the attenuator parameter.

8. The hybrid access encoder of claim 2, wherein the fixed-quality control module further comprises an averaging module that calculates an averaged version of an instantaneous quality metric.

9. The hybrid access encoder of claim 2, wherein the fixed-rate control module further comprises an averaging module that calculates an averaged version of an instantaneous rate metric.

10. The hybrid access encoder of claim 2, wherein the feedback loop further comprises an attenuation parameter limiting module configured to receive the attenuation parameter from the attenuation parameter module and pass a limited attenuation parameter to the hybrid access encoder.

11. The hybrid access encoder of claim 1, preceded by at least one of the following pre-processors:
a Bayer matrix to RGB conversion pre-processor;
an RGB to YUV conversion pre-processor; and,
an RGB to YCbCr conversion pre-processor.

12. A method for compressing a reference frame, comprising the following steps:
a. receiving an unencoded reference frame in a macroblock format;
b. calculating a size of each encoded macroblock in the plurality of encoded macroblocks;
c. calculating a quality metric of each encoded macroblock in the plurality of encoded macroblocks;
d. encoding each macroblock of the unencoded reference frame based on the size and quality metric to form a plurality of encoded macroblocks corresponding to the reference frame;
e. generating a directory of pointers to macroblock addresses for the plurality of encoded macroblocks corresponding to the video frame based on the quality and size of each encoded macroblock; and,
f. storing the plurality of encoded macroblocks in memory.

13. The method of claim 12, further comprising the following steps:
a. determining a macroblock address for a desired encoded macroblock from the plurality of encoded macroblocks using the directory of pointers;
b. retrieving the desired encoded macroblock from the memory in accordance with the macroblock address; and,
c. decoding the desired encoded macroblock to produce a decoded macroblock.

14. The method of claim 12, wherein each reference frame is encoded using two passes through steps a through d, where the compression parameters applied during the second pass are determined after the first pass.

15. The method claim 14, where each reference frame is encoded using more than two passes through steps a through d, where the compression parameters are compared after each pass to one or more acceptability metrics and modified according to the difference between the desired metric and the actual metric.

16. The method claim 12, wherein the step of encoding further comprises continuously updating the size and quality metrics as encoded proceeds from macroblock to macroblock.

17. The method of claim 12, wherein the step of receiving an unencoded reference frame includes receiving the unencoded reference frame from an H.264 encoder for motion estimation.

18. The method of claim 13, wherein the step of decoding the decoded macroblock further comprises passing the decoded macroblock to an H.264 decoder for motion estimation.
